(19) United States
(12) Patent Application Publication
(10) Pub. No.: US 2009/0031139 A1
(43) Pub. Date: Jan. 29, 2009

(54) System and Method for Electronic Certification and Authentification

(76) Inventor: Mohammed Alawi Geoffrey, Jeddah (SA)

Correspondence Address: FURR LAW FIRM, 2622 DEBOLT ROAD, UTICA, OH, 43080, US

(21) Appl. No.: 11/829,639

(22) Filed: Jul. 27, 2007

(51) Int. Cl. H04L 9/32

(52) U.S. Cl. 713/186

(57) ABSTRACT

The invention relates to electronic document security systems and in particular to user authentication and to the certification and secure transfer of sensitive document information of various type, like whole documents, certificates, signatures, stamps, etc., especially by verifying its correctness and safety/immunity from fraud.

### FIELD OF THE INVENTION

The invention relates to electronic document security systems and in particular to user authentication and to the certification and secure transfer of sensitive document information of various type, like whole documents, certificates, signatures, stamps, etc., especially by verifying its correctness and safety/immunity from fraud.

### BACKGROUND OF THE INVENTION

Current systems use stickers, thermal stamps and watermarks to safeguard against and to discover fraud, mostly by using the naked eye as a detector. The naked eye poses the problem that it is relatively unreliable so that many cases of fraud occur.

Further, a conventional approach for securing transfer, verification and storage of sensitive data which uses smart cards is still rather costly.

EP 1 688 891 describes an electronic certification and authentication system comprising a plurality of hierarchically structured modules which can be accessed by entering an enrolled identity and a corresponding passwords and/or a corresponding signature. Document information can be entered, certified, and saved in and, at a later date, read out from a system database by an authorized person.

However, there still exists a need to improve certification, authentification, and transfer of sensitive information by more reliable and more economical means.

### SUMMARY OF THE INVENTION

According to the present invention, there are provided a system and a method for electronic certification and authentication as defined by independent claims 1 and 10.

Further advantageous features of the invention are defined in the dependent subclaims.

According to a first aspect of the invention there is provided a system for electronic certification and authentication, comprising a main module, a first subordinate module, a database for storing personal data and biometric data, and a biometric device for capturing biometric data, wherein the main module is configured to:

generate a first asymmetric key pair for encrypting and decrypting biometric data;
generate a second asymmetric key pair for encrypting and decrypting personal data; enroll a client for the first subordinate module by:
capturing personal data of the client;
encrypting personal data of the client with a first key of the second asymmetric key pair;
storing the encrypted personal data of the client in the database;
capturing biometric data of the client by means of the biometric device;
encrypting the captured biometric data of the client with a first key of the first asymmetric key pair;
storing the encrypted biometric data of the client in the database; and
providing a client identity and a client password;
   and wherein the first subordinate module is configured to:
certify an identity of a client by:
   capturing biometric data of the client by means of the biometric device;
   decrypting the biometric data of the client which is stored in the database with a second key of the first asymmetric key pair; and
      comparing the biometric data captured by the biometric device with the decrypted biometric data stored in the database.

According to a second aspect of the invention, there is provided a method for electronic certification and authentication for use in a system comprising a main module, first subordinate module, a second subordinate module, a database for storing biometric data, and a biometric device for capturing biometric data;

wherein the method comprises the following steps carried out by the main module:
generating a first asymmetric key pair for encrypting and decrypting biometric data;
generating a second asymmetric key pair for encrypting and decrypting personal data;
enrolling a client for the first subordinate module by:
encrypting personal data of the client with a first key of the second asymmetric key pair;
storing the encrypted personal data of the client in the database;
capturing biometric data of the client by the biometric device;
encrypting the captured biometric data of the client with a first key of the first asymmetric key pair; and
storing the encrypted biometric data of the client in the database;
   assigning a client password and a client identity to the client;
   and wherein the method further comprises the following steps carried out by the first subordinate module:
   certifying an identity of a client by:
capturing biometric data of the client by means of the biometric device;
decrypting the biometric data of the client which is stored in the database with a second key of the first asymmetric key pair;
   comparing the biometric data captured by the biometric device with the decrypted biometric data stored in the database.

### BRIEF DESCRIPTION OF THE DRAWINGS

In order that the invention may be more readily understood and put into practice, preferred embodiments of the invention will now be described with reference to the accompanying drawings, in which:

FIG. 1 shows a simplified exemplary schematic diagram of a system according to an embodiment of the invention implemented in a communication network;

FIG. 2 shows a simplified exemplary flowchart of steps carried out by a capturing plug-in module according to a further embodiment of the invention;

FIG. 3 shows a simplified exemplary flowchart illustrating steps for verifying identity data offline;

FIG. 4 shows a simplified exemplary flowchart illustrating steps for verifying an identity of a client and member, respectively, offline;

FIG. 5 shows a simplified exemplary flowchart illustrating steps for verifying document data offline.

It is understood that this exemplary description does not limit the scope of the invention.

### DETAILED DESCRIPTION OF THE INVENTION

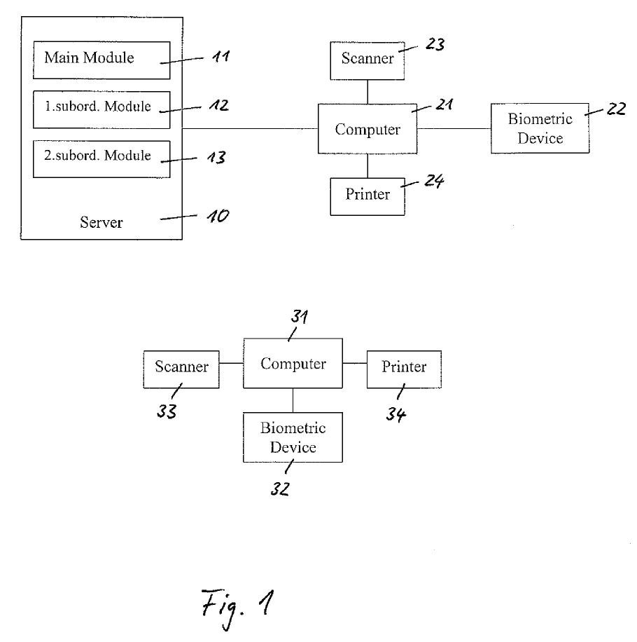

The system according to the invention comprises a plurality of hierarchically structured modules. The embodiment shown in FIG. 1 includes three hierarchically structured modules, main module 11, first subordinate module 12, and second subordinate module 13, but other embodiments comprising four or more hierarchically structured modules are also possible. For example, the modules run on a server connected to a database 14. A computer 21 is connected, e.g. by an internet connection with the server 10. Further, the computer 21 is connected to a biometric device 22, a scanner 23, and a printer 24. In FIG. 1, there is also shown a further computer 31, which is connected to a further biometric device, a further scanner 33, and a further printer 34. However, the further computer 31 is not connected to the server 10 and is therefore also called “stand alone computer” in the following.

The server 10 is preferably placed in a trusted environment (e.g. a trust center), as for example in the data centre of certification offices.

The main module 11 updates its data by connecting to the database 14 and/or by connecting to one of the subordinate modules 12 and 13. The main module 11 is preferably accessed by means of an internet browser plug-in from a computer having an internet browser installed.

The process to use the system usually starts with an authorized person causing the main module to generate three asymmetric key pairs. A first asymmetric key pair will be used to certify biometric data of clients of the first subordinate module 12 and members of the second subordinate module 13, respectively, a second asymmetric key pair will be used to authenticate identity data of clients and members, respectively, and a third asymmetric key pair will be used to authenticate document data. The system may generate these key pairs at the first time the system is used, but authorized persons may generate a new set of key pairs at a later time. Each key pair set may be assigned a name and a number which identifies the generation number of the respective set.

As a next step, the authorized person may enroll a client for the first subordinate module 12 to grant a further person, the client, access to the first subordinate module 12. In order to enroll a client for the first subordinate module 12, personal data of the client is entered, encrypted with a first key of the second asymmetric key pair, and stored in the database 14. Then, biometric data of the client is captured by the biometric device 22, encrypted with a first key of the first asymmetric key pair, and stored in the database 14. After storing encrypted identity data of the client, i.e. the encrypted personal and biometric data of the client, in the database 14 a client identity and password is assigned to the client for accessing the first subordinate module 12.

Further, a 2D barcode of the client identity data may be generated.

A 2D barcode usually has bars placed on the horizontal and the vertical dimensions and is generated using a 2D barcode generation program which transfers information into bars form. To be able to transform longer documents in barcode form, the document information is compressed.

For the 2D barcode of the client identity data, the personal data and the biometric data of the client are compressed and encrypted with a system generated random key, the system generated random key is encrypted with a first key of the second asymmetric key pair, and the 2D barcode is then generated from the encrypted system generated random key concatenated with the compressed personal and biometric data of the client.

The 2D barcode serves as a sort of “certificate of authenticity” for confirming that the associated data of the client is authentic to the system.

After generating the 2D barcode, a client identity card comprising the 2D barcode may be printed.

The first subordinate module 12, which preferably runs on the server 10 in a trusted environment, can be accessed by clients which have been enrolled for the first subordinate module 12 in two different ways:

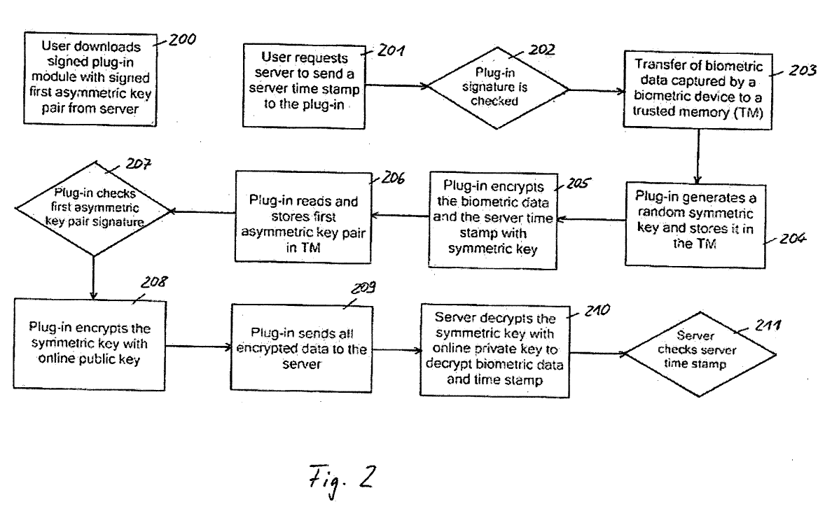

First, on the computer 21 which is connected, e.g. by an internet connection with the server 10, the first subordinate module 12 may be preferably accessed by means of a plug-in for an internet browser which will be described in detail with reference to FIG. 2. The client then enters his client identity and password to be granted access to the first subordinate module 12.

Second, either on the computer 21 or on the “stand alone” computer 31, the client may scan his client identity card by means of the scanner 23 and 33, respectively, and enter his client password to be granted access to the first subordinate module 12.

The first subordinate module 12 may be used by a certified client to enroll a further person, a so-called member, for the second subordinate module 13.

To certify an identity of the client online, e.g. on the computer 21, which is connected to the server 10, biometric data of the client is captured by means of the biometric device 22 and biometric data of the client which is stored in the database 14 is decrypted with a second key of the first asymmetric key pair and, as last step, the biometric data captured by the biometric device 22 is compared with the decrypted biometric data stored in the database 14. If the comparison is accepted the identity of the client is certified.

Additionally or alternatively, the biometric data of the client captured by the biometric device 22 can be compared with the biometric data of the client stored on his client identity card.

To enroll a member for the second subordinate module, personal data of the member are entered, encrypted with the first key of the second asymmetric key pair, and stored in the database 14. Then, biometric data of the member is captured by the biometric device 22, encrypted with the first key of the first asymmetric key pair, and stored in the database 14. After storing encrypted identity data of the member, i.e. the encrypted personal and biometric data of the client, in the database 14 a member identity and password is assigned to the member for accessing the second subordinate module 13.

Further, a 2D barcode of the member identity data may be generated: The personal data and the biometric data of the member are compressed and encrypted with a system generated random key, the system generated random key is encrypted with the first key of the second asymmetric key pair, and the 2D barcode is then generated from the encrypted system generated random key concatenated with the compressed personal and biometric data of the member. After generating the 2D barcode, a member identity card comprising the 2D barcode may be printed.

The second subordinate module 13, which preferably runs on the server 10 in a trusted environment (but which can also run on a further server or computer connected to the server 10) can be accessed by members enrolled for the second subordinate module 13 in two different ways:

First, on the computer 21 which is connected, e.g. by an internet connection with the server 10, the second subordinate module 13 may be preferably accessed by means of the internet browser plug-in. The member enters his member identity and password to be granted access to the second subordinate module 13.

Second, either on the computer 21 or on the “stand alone” computer 31, the member may scan his member identity card by means of the scanner 23 and 33, respectively, and enter his member password to be granted access to the second subordinate module 13.

The second subordinate module 13 may be used by a member to authenticate data and print the data or authorize a further member to print the data.

As first steps, document data may be entered and uploaded, respectively, and an identity of the member has to be certified.

To certify the identity of the member online, e.g. on the computer 21, which is connected to the server 10, biometric data of the member is captured by means of the biometric device 22, and biometric data of the member which is stored in the database 14 is decrypted with the second key of the first asymmetric key pair, and the biometric data captured by the biometric device 22 is compared with the decrypted biometric data stored in the database 14. If the comparison is accepted the identity of the member is certified.

Additionally or alternatively, the biometric data of the member captured by the biometric device 22 can be compared with the biometric data of the member stored on his client identity card.

Then, the certified member can cause the second subordinate module 13 to generate a document 2D barcode for document data. Thereupon, the second subordinate module 13 generates a data hash code from the document data, encrypts the data hash code with a first key of the third asymmetric key pair, compresses the document data, and generates the document 2D barcode from the encrypted hash code concatenated with the compressed document data.

Subsequently, the certified member can print the document data together with the generated document 2D barcode or can authorize a further member to print the document data together with the generated document 2D barcode by assigning a member identity and password to the further member.

Some of the functionalities of the system 10, which are often used, may be implemented as separate modules, which may be called by the main module or one of the subordinate modules. This is especially advantageous for systems comprising a plurality of subordinate modules.

For example, the functionalities of enrolling a client, member and/or user for a further subordinate module and/or of certifying an identity of a client, member of a further subordinate module may be implemented as respective modules.

As mentioned before, the computer 21 is connected to the server 10, preferably by an internet connection. For this purpose, a plug-in module may be implemented in the computer 21 of a client/member to secure transfer of sensitive data (especially captured biometric data), between the server 10, the computer 21, and the biometric device 22.

The steps carried out by the plug-in module are illustrated, by way of example, for the process of capturing biometric data online, in the simplified flowchart of FIG. 2:

Before using the plug-in module for the first time, a client/member downloads, 200, the signed plug-in module with a signed first asymmetric key pair from the server 10 and installs it on e.g. computer 21. The client/member requests, 201, the server 10 to send a server time stamp to the plug-in module. The plug-in module checks, 202, its own signature. If it is ok, the client/member can transfer, 203, biometric data captured by the biometric device 22 to a trusted memory (TM) by means of the plug-in module. TM can be encrypted memory, a trusted platform module or protected memory and may be part of the database 14. The plug-in module generates, 204, a random symmetric key and stores it in the TM. The plug-in module encrypts, 205, the captured client/member biometric data and the server time stamp with the symmetric key. The plug-in module reads and stores, 206, the first asymmetric key pair in the TM. The plug-in module checks, 207, the signature of the first asymmetric key pair. If it is ok, the plug-in module encrypts, 208, the symmetric key with the first asymmetric key pair. The plug-in module sends, 209, all the encrypted data to the server 10. The server 10 decrypts, 210, the symmetric key with the first asymmetric key pair and decrypts, 210, the biometric data and the server time stamp with the symmetric key. The server 10 finally checks, 211, the server time stamp and if it is ok, accepts the biometric data captured by the biometric device 22.

Though the functionality of the plug-in module has been exemplarily illustrated for the process of capturing biometric data online, the plug-in module may certainly be used for secure transfer of any kind of sensitive data.

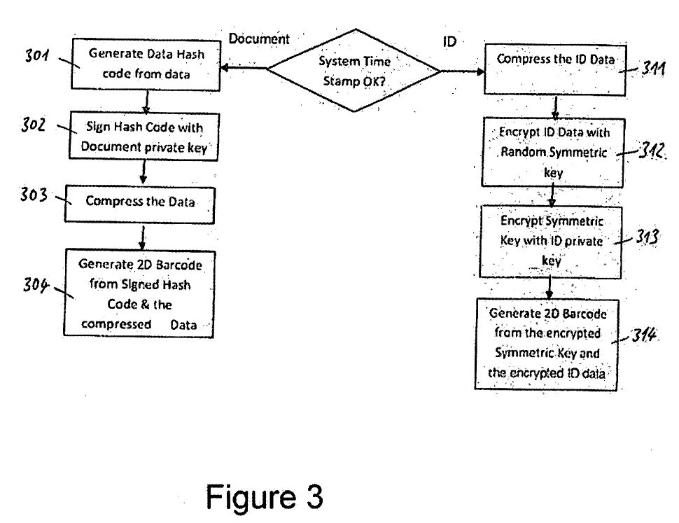

FIG. 3 refers to an example of a separate module having a special functionality, the certification of document and/or identity data. In FIG. 3, a simplified exemplary flowchart illustrating steps for providing a certificate of authenticity for data entered or uploaded on a document or an identity card.

If data is entered for a document a 2D barcode is generated, 301, from the hash code of the data, the hash code is encrypted, 302, with a document private key, the data is compressed, 303, and a hash code is generated, 304, from the encrypted hash code and the compressed data.

If data is entered for an identity card the identity data is compressed, 311, encrypted, 312, with a symmetric key randomly generated, the symmetric key is encrypted, 313, with an identity private key, and a 2D barcode is generated, 314, from the encrypted symmetric key and the encrypted compressed data.

The 2D barcode respectively serves as a “certificate of authenticity” which marks the associated data as authentic to the system and created by a certified client/member.

The system shown in FIG. 1 further provides a facility to verify document data and identity data of clients and members offline on the “stand-alone” computer 31.

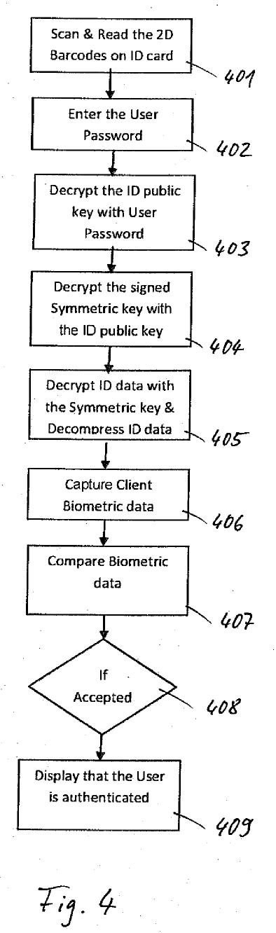

FIG. 4 shows a simplified exemplary flowchart illustrating steps for certifying identity data offline carried out by a offline verification module implemented in the computer 31. First, a printed 2D barcode comprising client/member identity data, i.e. personal and biometric data of the client/member, is scanned by means of the scanner 33 and read out, 401, for example from a client/member identity card, and the client/member enters, 402, his password. Then, the second asymmetric key pair, also referred to as “identity public key”, is decrypted 403 with the client/member password, if necessary, i.e. if the identity public key has been encrypted with the client/member password before. The encrypted system generated random key is decrypted, 404, with the second key of the second asymmetric key pair and the decrypted system generated random key is used for decrypting the identity data and the decrypted identity data which comprises the biometric data of the client/member is decompressed, 405.

Additionally, biometric data of the client/member to be certified is captured, 406, by means of the biometric device 32 connected to the computer 31.

To certify the identity of the client/member, the biometric data from the 2D barcode of the e.g. identity card of the client/member is compared, 407, with the biometric data of the client/member captured by means of the biometric device 32. If the comparison is acceptable, 408, the identity of the client/member is certified offline, 409.

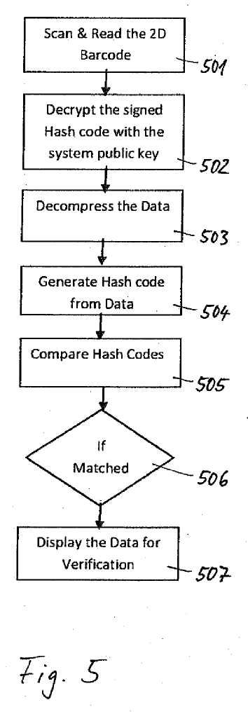

FIG. 5 shows a simplified exemplary flowchart illustrating steps for verifying document data carried out offline by the offline verification module or a further separate module implemented in the computer 31. First, a document 2D barcode is scanned by means of the scanner 33 and read out, 501, for example from a print-out comprising document data and the corresponding document 2D barcode. Then, the encrypted hash code is decrypted, 502, with a second key of the third asymmetric key pair (also referred to as “system public key”), the data is decompressed, 503, and a hash code is generated, 504, from the decompressed data. Thereafter, the just generated hash code is compared, 505, with the decompressed hash code. If both hash codes match, 506, the document data can be displayed, 507, for verification purposes.

1. A system for electronic certification and authentication, comprising:
a main module (11);
a first subordinate module (12);
a database (14) for storing personal data and biometric data, and
a biometric device (22) for capturing biometric data;
wherein the main module (11) is configured to:
generate a first asymmetric key pair for encrypting and decrypting biometric data;
generate a second asymmetric key pair for encrypting and decrypting personal data;
enroll a client for the first subordinate module (12) by:
capturing personal data of the client;
encrypting personal data of the client with a first key of the second asymmetric key pair;
storing the encrypted personal data of the client in the database (14);
capturing biometric data of the client by means of the biometric device (22);
encrypting the captured biometric data of the client with a first key of the first asymmetric key pair;
storing the encrypted biometric data of the client in the database (14); and
providing a client identity and a client password;
and wherein the first subordinate module (12) is configured to:
certify an identity of a client by:
capturing biometric data of the client by means of the biometric device (22);
decrypting the biometric data of the client which is stored in the database (14) with a second key of the first asymmetric key pair; and
comparing the biometric data captured by the biometric device (22) with the decrypted biometric data stored in the database (14).

2. The system of claim 1, further comprising a second subordinate module (13),
wherein the main module (11) is further configured to generate a third asymmetric key pair for encrypting and decrypting document data;
and wherein the first subordinate module (12) is further configured to:
enroll a member for the second subordinate module (13) by:
encrypting personal data of the member with the first key of the second asymmetric key pair;
storing the encrypted personal data of the member in the database (14);
capturing biometric data of the member by means of the biometric device (22);
encrypting the captured biometric data of the member with the first key of the first asymmetric key pair;
storing the encrypted biometric data of the member in the database (14); and
providing a member identity and a member password;
and wherein the second subordinate module (13) comprises means for entering and/or uploading document data and is configured to:
certify an identity of a member by:
capturing biometric data of the member by means of the biometric device (22);
decrypting the biometric data of the member which is stored in the database (14) with the second key of the first asymmetric key pair;
comparing the biometric data captured by the biometric device (22) with the decrypted biometric data stored in the database (14);
generate a document 2D barcode;
print the document data together with the generated document 2D barcode; and
authorize another member to print the document data together with the generated document 2D barcode.

3. The system of claim 2, wherein the second subordinate module (13) is further configured to:
generate a data hash code from the document data;
encrypt the data hash code with a first key of the third asymmetric key pair;
compress the document data;
generate the document 2D barcode from the encrypted hash code concatenated with the compressed document data.

4. The system of according to claim 2, wherein the main module (11) is further configured to:
compress the personal data of the client and the biometric data of the client;
encrypt the compressed personal and biometric data of the client with a system generated random key;
encrypt the system generated random key with the first key of the second asymmetric key pair;
generate a 2D barcode from the encrypted system generated random key concatenated with the compressed personal and biometric data of the client;
print a client identity card comprising the 2D barcode.

5. The system according to claim 3, wherein the main module (11) is further configured to:
compress the personal data of the client and the biometric data of the client;
encrypt the compressed personal and biometric data of the client with a system generated random key;
encrypt the system generated random key with the first key of the second asymmetric key pair;
generate a 2D barcode from the encrypted system generated random key concatenated with the compressed personal and biometric data of the client;
print a client identity card comprising the 2D barcode.

6. The system of claim 5, wherein the first subordinate module (12) is further configured to:
compress the personal data of the member and the biometric data of the member;
encrypt the compressed personal and biometric data of the member with a system generated random key;
encrypt the system generated random key with the first key of the second asymmetric key pair;
generate a further 2D barcode from the encrypted system generated random key concatenated with the compressed personal and biometric data of the member;
print a member identity card comprising the further 2D barcode.

7. The system of claim 6, further comprising a verification module for a computer (31) connected to a scanner (33) and a further biometric device (32),
the verification module being configured to certify an identity of a client by:
capturing biometric data by means of the further biometric device (32);
reading the client identity card of the client by means of the scanner (33);
decrypting the system generated random key comprised in the 2D barcode of the client identity card with the second key of the second asymmetric key pair;
comparing the biometric data of the client, which is captured by the further biometric device (32) with the biometric data of the client from the client identity card.

8. The system of claim 7, wherein the verification module is further configured to certify an identity of a member by:
capturing biometric data by means of the further biometric device (32);
reading the member identity card of the member by means of the scanner (33);
decrypting the system generated random key comprised in the 2D barcode of the member identity card with the second key of the second asymmetric key pair;
comparing the biometric data of the member, which is captured by the further biometric device (32) with the biometric data of the member from the member identity card.

9. The system according to claim 2, wherein at least one module of the main module (11), the first and the second subordinate modules (12, 13) is accessible over the internet using an internet browser.

10. The system according to claim 2, wherein access to the first and the second subordinate modules (12, 13), respectively, is granted by entering the client identity and member identity, respectively, and the client password and member password, respectively.

11. A method for electronic certification and authentication for use in a system comprising a main module (11), first subordinate module (12), a second subordinate module (13), a database (14) for storing biometric data, and a biometric device (22) for capturing biometric data;
the method comprising the following steps carried out by the main module (11):
generating a first asymmetric key pair for encrypting and decrypting biometric data;
generating a second asymmetric key pair for encrypting and decrypting personal data;
enrolling a client for the first subordinate module (12) by:
encrypting personal data of the client with a first key of the second asymmetric key pair;
storing the encrypted personal data of the client in the database (14);
capturing biometric data of the client by the biometric device (22);
encrypting the captured biometric data of the client with a first key of the first asymmetric key pair; and
storing the encrypted biometric data of the client in the database (14);
assigning a client password and a client identity to the client;
the method further comprising the following steps carried out by the first subordinate module (12):
certifying an identity of a client by:
capturing biometric data of the client by means of the biometric device (22);
decrypting the biometric data of the client which is stored in the database (14) with a second key of the first asymmetric key pair;
comparing the biometric data captured by the biometric device (22) with the decrypted biometric data stored in the database (14).

12. The method of claim 11, further comprising:
the step of generating, by the main module (11), a third asymmetric key pair for encrypting and decrypting document data;
the following steps carried out by the first subordinate module (12):
enrolling a member for the second subordinate module (13) by:
encrypting personal data of the member with the first key of the second asymmetric key pair;
storing the encrypted personal data of the member in the database (14);
capturing biometric data of the member by the biometric device (22);
encrypting the captured biometric data of the member with the first key of the first asymmetric key pair; and
storing the encrypted biometric data of the member in the database (14);
providing a member password and a member identity;
the following steps carried out by the second subordinate module (13):
entering and/or uploading document data;
certifying an identity of a member by:
capturing biometric data of the member by means of the biometric device (22);
decrypting the biometric data of the member which is stored in the database (14) with the second key of the first asymmetric key pair;
comparing the biometric data captured by the biometric device (22) with the decrypted biometric data stored in the database (14);
generating a document 2D barcode; and
printing the document data together with the generated document 2D barcode.

13. The method of claim 12, further comprising the following step carried out by the second subordinate module (13):
authorizing another member to print the document data together with the generated document 2D barcode.

14. The method according to claim 12, wherein the step of generating the document 2D barcode comprises:
generating a data hash code from the document data;
encrypting the data hash code with a first key of the third asymmetric key pair;
compressing the document data; and
generating the document 2D barcode from the encrypted hash code concatenated with the compressed document data.

15. The method according to claim 12, further comprising the following steps carried out by the main module (11):
compressing the personal data of the client and the biometric data of the client;
encrypting the compressed personal and biometric data of the client with a system generated random key;
encrypting the system generated random key with the first key of the second asymmetric key pair;
generating a 2D barcode from the encrypted system generated random key concatenated with the compressed personal and biometric data of the client; and
printing a client identity card comprising the 2D barcode.

16. The method according to claim 15, further comprising the following steps carried out by the first subordinate module (12):
compressing the personal data of the member and the biometric data of the member;
encrypting the compressed personal and biometric data of the member with a system generated random key;
encrypting the system generated random key with the first key of the second asymmetric key pair;
generating a further 2D barcode from the encrypted system generated random key concatenated with the compressed personal and biometric data of the member;
generating a further 2D barcode comprising the encrypted personal data of the member and the encrypted biometric data of the member; and
printing a member identity card comprising the further 2D barcode.

17. The method according to claim 15, further comprising the step of certifying an identity of a client by:
capturing biometric data of the client by means of the biometric device (22);
reading the client identity card of the client by means of a scanner (23);
decrypting the system generated random key comprised in the 2D barcode of the client identity card with the second key of the second asymmetric key pair;
comparing the biometric data of the client, which is captured by the biometric device (22) with the biometric data of the client from the client identity card.

18. The method according to claim 16, further comprising the step of certifying an identity of a member by:
capturing biometric data of the member by means of the biometric device (22);
reading the member identity card of the member by means of a scanner (23);
decrypting the system generated random key comprised in the 2D barcode of the member identity card with the second key of the second asymmetric key pair;
comparing the biometric data of the member, which is captured by the biometric device (22) with the biometric data of the member from the member identity card.

19. The method according to claim 11, further comprising the step of accessing at least one module of the main module (11), the first and the second subordinate modules (12, 13) over the internet using an internet browser.

20. The method according to claim 11, further comprising the step of entering the client identity and member identity, respectively, and the client password and member password, respectively, to access the first and the second subordinate modules (12, 13), respectively.
